(19) United States
(12) Patent Application Publication
(10) Pub. No.: US 2025/0360690 A1
(43) Pub. Date: Nov. 27, 2025

(54) HEAT SHRINKABLE MULTILAYER FILM

(71) Applicant: GUNZE LIMITED, Kyoto (JP)

(72) Inventor: Takuya IKEDA, Shiga (JP)

(73) Assignee: GUNZE LIMITED, Kyoto (JP)

(21) Appl. No.: 18/880,331

(22) PCT Filed: Jun. 7, 2023
(86) PCT No.: PCT/JP2023/021176

§ 371 Date: Dec. 31, 2024

(30) Foreign Application Priority Data
Jul. 5, 2022 (JP) 2022-108499

(51) Int. Cl. B32B 7/028; B32B 27/08; B32B 27/32

(52) U.S. Cl. CPC B32B 7/028; B32B 27/08; B32B 27/325; B32B 2250/03; B32B 2250/242; B32B 2250/40; B32B 2307/30

(57) ABSTRACT

This heat shrinkable multilayer film is provided with a pair of surface layers, and an intermediate layer disposed between the pair of surface layers. Each of the surface layers contains a total of at least 45 parts by weight of one or more thermoplastic resins selected from hydrocarbon-based resins, ethylene-based resins, and propylene-based copolymer resins, but does not contain a cyclic olefin-based resin or contains the same in an amount more than 0 but less than 55 parts by weight. The intermediate layer contains one or more thermoplastic resins selected from hydrocarbon-based resins, ethylene-based resins, and propylene-based copolymer resins, but does not contain a cyclic olefin-based resin or contains a cyclic olefin-based resin at a content ratio less than that of the cyclic olefin-based resin in the surface layers.

### TECHNICAL FIELD

The present disclosure relates to a heat shrinkable multilayer film.

### BACKGROUND ART

Patent Literature 1 discloses a low-temperature heat shrinkable film that does not impair transparency or glossiness even after heat shrinkage. In the low-temperature heat shrinkable film disclosed in Patent Literature 1, both surface layers are made of a resin composition obtained by mixing 50 parts by weight to 150 parts by weight petroleum resin and/or terpene resin and 50 parts by weight to 800 parts by weight polyolefin thermoplastic elastomer with respect to 100 parts by weight of polypropylene-based resin, and an intermediate layer is made of a polyethylene-based resin. According to Patent Literature 1, the low-temperature heat shrinkable film disclosed in Patent Literature 1 has a heat shrinkage in a lateral direction of 47% when it is immersed in hot water at 90° C. for 10 seconds.

Patent Literature 2 also discloses a multilayer heat shrinkable film. According to Patent Literature 2, the multilayer heat shrinkable film disclosed in Patent Literature 2 has a heat shrinkage in a lateral direction of 50% or more when it is immersed in hot water at 90° C. for 10 seconds.

### CITATION LIST

### Patent Literature

Patent Literature 1: JP-A-2003-136650

Patent Literature 2: WO 2004/110750

### SUMMARY OF THE INVENTION

### Technical Problems

While the heat shrinkable film disclosed in Patent Literature 1 is said to have a good heat-shrinkable property at 90° C., the heat shrinkage at 90° C. is preferably higher for practical use. On the other hand, while the heat shrinkable film disclosed in Patent Literature 2 has a sufficiently high heat shrinkage at 90° C., it has a relatively high content of cyclic olefin-based resin, especially in front and back film layers. Therefore, it is difficult to control sebum whitening properties, and the manufacturing cost increases. In addition, while this type of heat shrinkable films is often used as a base material for cylindrical labels that are sealed at both end portions and attached to containers, the heat shrinkable films disclosed in Patent Literatures 1 and 2 do not take into account their suitability for ultrasonic welding.

An object of the present disclosure is to provide a heat shrinkable multilayer film that has a relatively high heat shrinkage, suppresses sebum whitening, has a low manufacturing cost, and is suitable for ultrasonic welding.

### Solutions to the Problems

A heat shrinkable multilayer film according to a first aspect of the present disclosure includes a pair of surface layers and an intermediate layer disposed between the pair of surface layers. Each of the surface layers contains one or a plurality of thermoplastic resins selected from one or a plurality of hydrocarbon resins, an ethylene-based resin, and a propylene-based copolymer resin in a combined amount of 45 parts by weight or more with respect to 100 parts by weight of a total of thermoplastic resins contained in the surface layers and does not contain a cyclic olefin-based resin or contains a cyclic olefin-based resin in an amount of more than 0 parts by weight and less than 55 parts by weight, and the one or the plurality of hydrocarbon resins is selected from a petroleum resin, a terpene resin, and a rosin resin. The intermediate layer contains one or a plurality of thermoplastic resins selected from one or a plurality of hydrocarbon resins, an ethylene-based resin, and a propylene-based copolymer resin and does not contain a cyclic olefin-based resin or contains a cyclic olefin-based resin such that a content ratio of a cyclic olefin-based resin with respect to 100 parts by weight of a total of thermoplastic resins contained in the intermediate layer is lower than a content ratio of a cyclic olefin-based resin in the surface layers, and the one or the plurality of hydrocarbon resins is selected from a petroleum resin, a terpene resin, and a rosin resin.

A heat shrinkable multilayer film according to a second aspect of the present disclosure is the heat shrinkable multilayer film according to the first aspect, in which the surface layers contain the cyclic olefin-based resin.

A heat shrinkable multilayer film according to a third aspect of the present disclosure is the heat shrinkable multilayer film according to the first aspect or the second aspect, in which the surface layers contain the cyclic olefin-based resin in an amount of 1 part by weight or more with respect to 100 parts by weight of a total of thermoplastic resins contained in the surface layers.

A heat shrinkable multilayer film according to a fourth aspect of the present disclosure is the heat shrinkable multilayer film according to any one of the first to the third aspects, in which the intermediate layer contains the cyclic olefin-based resin.

### Advantageous Effects of the Invention

The present disclosure provides a heat shrinkable multilayer film that has a relatively high heat shrinkage, suppresses sebum whitening, has a low manufacturing cost, and is suitable for ultrasonic welding.

### BRIEF DESCRIPTION OF THE DRAWINGS

FIG. 1A is a cross-sectional schematic diagram of a heat shrinkable multilayer film.

FIG. 1B is a cross-sectional schematic diagram of a printed film and the like including the heat shrinkable multilayer film.

FIG. 2 is a diagram describing a method for producing a heat-shrinkable cylindrical label (mainly a print area forming step).

FIG. 3 is a diagram describing the production method of the heat-shrinkable cylindrical label.

FIG. 4 is a flowchart showing a flow of the production method of the heat-shrinkable cylindrical label.

FIG. 5 is a diagram describing an overcoat area forming step.

FIG. 6A is a lateral cross-sectional schematic diagram of a superimposed portion.

FIG. 6B is a lateral cross-sectional schematic diagram of a superimposed portion according to a modification.

FIG. 7 is a diagram describing a sealing method using an ultrasonic welding machine.

FIG. 8A is a lateral cross-sectional schematic diagram of a seal line.

FIG. 8B is a lateral cross-sectional schematic diagram of a seal line according to a modification.

FIG. 9 is a lateral cross-sectional schematic diagram of a label area according to a modification.

FIG. 10 is a diagram describing a failure of the seal line.

### DESCRIPTION OF EMBODIMENTS

Hereinafter, a heat shrinkable multilayer film according to the present disclosure and a method for producing a heat-shrinkable cylindrical label including the heat shrinkable multilayer film will be described by referring to the drawings. The drawings below are deformed appropriately for the convenience of explanation and do not necessarily reflect the actual dimensions or ratios thereof.

### 1. Outline

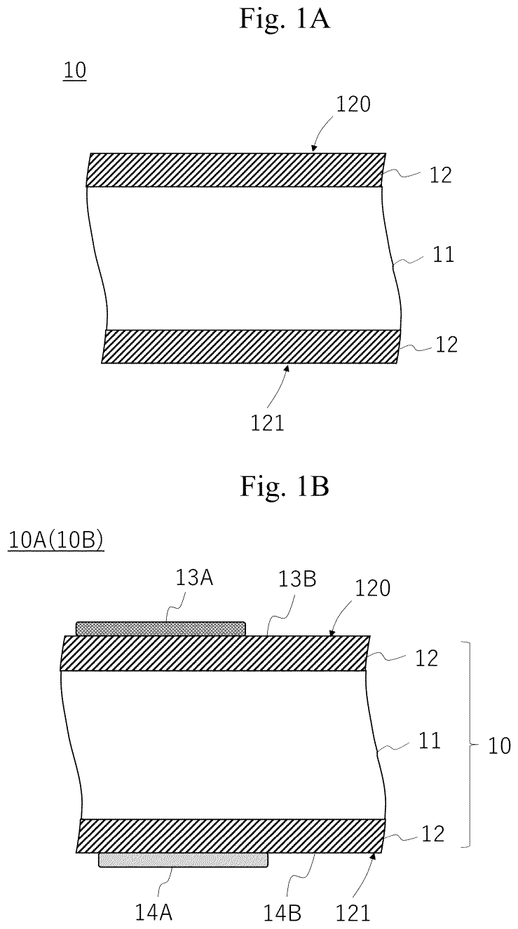

FIG. 1A is a cross-sectional schematic diagram illustrating a configuration of a heat shrinkable multilayer film 10 (hereinafter, also simply referred to as a “film 10”). The film 10 mainly contains a thermoplastic resin and is suitably used as a base material of a heat-shrinkable cylindrical label 1 (hereinafter, also simply referred to as a “cylindrical label 1”) as described later (see FIG. 3). The cylindrical label 1 is typically a shrink label attached to the outer side of plastic containers including PET bottles, metal containers, and glass containers.

The film 10 is an olefin film containing as a main component an olefin-based resin as a thermoplastic resin and is configured to have an overall specific gravity of less than 1. Examples of the olefin-based resin include a hydrocarbon resin such as a petroleum resin, a terpene resin, and a rosin resin, an ethylene-based resin, a propylene-based resin, a cyclic olefin-based resin and a mixed resin obtained by mixing at least two kinds of these resins.

As illustrated in FIG. 1A, the film 10 of the present embodiment has a three-layer structure and includes a pair of surface layers 12 and an intermediate layer 11 disposed between the pair of surface layers 12. In the present embodiment, each surface layer 12 is laminated adjacent to a front surface and a back surface of the intermediate layer 11. Each of the intermediate layer 11 and the surface layers 12 mainly contains the olefin-based resin described above. In addition, each of the surface layers 12 of the present embodiment constitutes an outer side surface of the film 10. Hereinafter, one surface of the film 10 constituted of the surface layer 12 is referred to as a first surface 120, and a surface on the back side of the first surface 120 is referred to as a second surface 121. Each layer will be described below.

### 2. Surface Layer

The surface layer 12 contains one or a plurality of thermoplastic resins selected from a hydrocarbon resin, an ethylene-based resin, and a propylene-based copolymer resin. The hydrocarbon resin is one or a plurality of thermoplastic resins selected from a petroleum resin, a terpene resin, and a rosin resin. In addition, a cyclic olefin-based resin can be further contained. Each resin will be described below.

### [Petroleum Resin]

The petroleum resin is a resin obtained by polymerizing remaining C4 to C5 fractions (mainly a C5 fraction) or C5 to C9 fractions (mainly a C9 fraction) after the removal of ethylene, propylene, butadiene, and the like by thermal decomposition of naphtha, or a mixture thereof. Specific examples include alicyclic petroleum resins from cyclopentadiene or its dimer, aromatic petroleum resins from C9 components, copolymers thereof, and the like. A hydrogenated alicyclic petroleum resin having a partially or completely hydrogenated alicyclic structure is preferable from the viewpoint of suppressing softening of the film 10 at 100° C. or lower and securing transparency and rigidity. It is also possible to use a product obtained by purifying and polymerizing a single component or a plurality of components in the C5 fraction and the C9 fraction.

The petroleum resin has a number average molecular weight measured by a gel permeation chromatography (GPC) method of preferably 500 or more and 1000 or less, more preferably 600 or more and 900 or less. By setting the number average molecular weight within the above range, the rigidity of the film 10 is improved.

The petroleum resin has a softening point of preferably 80° C. or higher and 170° C. or lower, more preferably 110° C. or higher and 155° C. or lower. When the softening point is lower than 80° C., heat resistance of the film 10 is lowered, and the petroleum resin component may be easily bled out to the surface in a high-temperature atmosphere. When the softening point is higher than 170° C., molding processability such as extrusion film formability and stretching processability may be deteriorated. On the other hand, when the softening point is 110° C. or higher, natural shrinkage of the film 10 can be suppressed, and when the softening point is 155° C. or lower, the film 10 can be uniformly stretched in a stretching step, which is preferable. In addition, in particular, when the softening point is 120° C. or higher and 140° C. or lower, a good heat-shrinkable property can be exhibited. The softening point of the petroleum resin is measured by a method in accordance with JIS K2207:2006.

The petroleum resin has a density of preferably 950 kg/m³ or more and 1050 kg/m³ or less, more preferably 980 kg/m³ or more and 1020 kg/m³ or less. When the petroleum resin has a density within the above range, the rigidity of the film 10 is improved.

When the above-described petroleum resin is a mixed resin containing two or more kinds of petroleum resins having different softening points, the softening point of the above-described petroleum resin is an apparent softening point calculated by summing the products of the softening points and mass % proportions of the respective petroleum resins. Further, the same applies to the density.

Examples of commercially available products of the petroleum resin as described above include I-MARV (manufactured by Idemitsu Kosan Co., Ltd.), ARKON (manufactured by Arakawa Chemical Industries, Ltd.), Regalite (manufactured by Eastman Chemical Company), and the like.

### [Terpene Resin and the Like]

Examples of the terpene resin include terpene resins from a-pinene or ß-pinene, copolymers of α-pinene, β-pinene, and the like, aromatic modified terpene resins, terpene-phenolic resins, and hydrogenated terpene resins. Examples of the rosin resin include gum rosin, wood rosin, tall oil rosin, esterified rosin denatured by glycerin, pentaerythritol, or the like, and hydrogenated rosin resins.

### [Ethylene-Based Resin]

Examples of the ethylene-based resin include linear low-density polyethylenes, branched low-density polyethylenes, ethylene-vinyl acetate copolymers, ionomer resins, and mixtures thereof. Furthermore, examples of the ethylene-based resin include a copolymer of ethylene and an α-olefin. The α-olefin is not particularly limited, and examples thereof include 1-butene, 1-pentene, 1-hexene, 4-methyl-1-pentene, and 1-octene, and may include two or more kinds of α-olefins. The copolymer may be a random copolymer or a block copolymer. Also, the ethylene-based resin may contain an ethylene elastomer or the like.

The ethylene-based resin has a Vicat softening temperature of preferably 45° C. or higher and 120° C. or lower, more preferably 50° C. or higher and 110° C. or lower, still more preferably 55° C. or higher and 100° C. or lower.

The ethylene-based resin has a melt flow rate (MFR, g/10 min) of preferably 1.0 or more and 6.0 or less, more preferably 1.5 or more and 5.0 or less, still more preferably 2.0 or more and 4.0 or less.

The ethylene-based resin has a density of preferably 850 kg/m³ or more and 950 kg/m³ or less, more preferably 870 kg/m³ or more and 920 kg/m³ or less.

When the above-described ethylene-based resin is a mixed resin containing two or more kinds of ethylene-based resins having different Vicat softening temperatures, the Vicat softening temperature of the above-described ethylene-based resin is an apparent Vicat softening temperature calculated by summing the products of the Vicat softening temperatures and mass % proportions of the respective ethylene-based resins. Further, the same applies to the density and MFR.

Examples of commercially available products of the ethylene-based resin as described above include Evolue (manufactured by Prime Polymer Co., Ltd.), UMERIT (manufactured by Ube-Maruzen Polyethylene Co., Ltd.), SUMIKATHENE (manufactured by Sumitomo Chemical Co., Ltd.), NOVATEC (manufactured by Japan Polyethylene Corporation), and the like.

### [Propylene-Based Copolymer Resin]

As the propylene-based copolymer resin, a propylene-based binary copolymer resin or a propylene-based ternary copolymer resin containing propylene as a main component and α-olefin as a copolymerization component is preferable, and a propylene-based ternary random copolymer resin is particularly preferable. The ratio of the α-olefin as a copolymerization component is preferably 1 mol % to 10 mol %. Also, the propylene-based copolymer resin may be a mixture of different propylene-α-olefin random copolymers. The α-olefin is as described above. In addition, the propylene-based copolymer resin may contain a propylene-based elastomer or the like.

The propylene-based copolymer resin improves the heat-shrinkable property of the film 10. In addition, since the propylene-based copolymer resin has a low melting point compared with homo-propylene, it improves weldability at a contact interface of a seal line 101. Furthermore, the propylene-based copolymer resin lowers surface roughness, thereby suppressing damage to a seal portion by an impact such as falling.

The propylene-based copolymer resin has a Vicat softening temperature of preferably 55° C. or higher and 135° C. or lower, more preferably 60° C. or higher and 130° C. or lower, still more preferably 65° C. or higher and 125° C. or lower.

The propylene-based copolymer resin has a melt flow rate (MFR, g/10 min) of preferably 1.0 or more and 8.0 or less, more preferably 2.0 or more and 7.0 or less, still more preferably 3.0 or more and 6.0 or less.

The propylene-based copolymer resin has a density of preferably 850 kg/m³ or more and 950 kg/m³ or less, more preferably 880 kg/m³ or more and 920 kg/m³ or less.

When the above-described propylene-based copolymer resin is a mixed resin containing two or more kinds of propylene-based copolymer resins having different Vicat softening temperatures, the Vicat softening temperature of the above-described propylene-based copolymer resin is an apparent Vicat softening temperature calculated by summing the products of the Vicat softening temperatures and mass % proportions of the respective propylene-based copolymer resins. Further, the same applies to the density and MFR.

### [Cyclic Olefin-Based Resin]

The cyclic olefin-based resin can lower the crystallinity of the film 10, increase the heat shrinkage, and also increase stretchability during production. The cyclic olefin-based resin is, for example, (a) a random copolymer of ethylene or propylene and a cyclic olefin, (b) a ring-opened polymer of the cyclic olefin or a copolymer with an α-olefin, (c) a hydrogenated product of the polymer of (b), (d) a graft-modified product of (a) to (c) with an unsaturated carboxylic acid, a derivative thereof, or the like.

The cyclic olefin is not particularly limited, and examples thereof include norbornene and derivatives thereof such as norbornene, 6-methylnorbornene, 6-ethylnorbornene, 5-propylnorbornene, 6-n-butylnorbornene, 1-methylnorbornene, 7-methylnorbornene, 5,6-dimethylnorbornene, 5-phenylnorbornene, and 5-benzylnorbornene. Furthermore, examples thereof include tetracyclododecene and derivatives thereof such as tetracyclododecene, 8-methyltetracyclo-3-dodecene, 8-ethyltetracyclo-3-dodecene, and 5,10-dimethyltetracyclo-3-dodecene. The α-olefin is as described above.

The cyclic olefin-based resin preferably has a number average molecular weight measured by a GPC method of 1000 or more and 1 million or less. When the number average molecular weight is within the above range, film formation is facilitated.

The cyclic olefin-based resin has a glass transition temperature of preferably 20° C. or higher and 130° C. or lower, more preferably 50° C. or higher and 100° C. or lower.

The cyclic olefin-based resin has a melt volume rate (MVR, cm³/min) of preferably 10.0 or more and 40.0 or less, more preferably 15.0 or more and 35.0 or less, still more preferably 20.0 or more and 30.0 or less.

When the above-described cyclic olefin-based resin is a mixed resin containing two or more kinds of cyclic olefin-based resins having different glass transition temperatures, the glass transition temperature of the above-described cyclic olefin-based resin is an apparent glass transition temperature calculated by summing the products of the glass transition temperatures and mass % proportions of the respective cyclic olefin-based resins. Further, the same applies to the MVR.

Examples of commercially available products of the cyclic olefin-based resin as described above include APEL (manufactured by Mitsui Chemicals, Inc.), TOPAS COC (manufactured by Polyplastics Co., Ltd.), ZEONOR (manufactured by Zeon Corporation), and the like.

### [Content Ratio]

The surface layers 12 contain the one or the plurality of hydrocarbon resins, the ethylene-based resin, and the propylene-based copolymer resin in a total amount of preferably 45 parts by weight or more, more preferably 55 parts by weight or more, still more preferably 65 parts by weight or more, with respect to 100 parts by weight of the total of the thermoplastic resins contained in the surface layers 12. It is only necessary for the surface layers 12 to contain at least one of the hydrocarbon resin, the ethylene-based resin, and the propylene-based copolymer resin, and it is not necessary to contain all of them.

In addition, the surface layers 12 may contain or need not contain the cyclic olefin-based resin. From the viewpoint of suppressing sebum whitening properties in the film 10, which cause sections touched by human hands to whiten after heat shrinkage and suppressing the cost of the film 10, it is particularly preferable that the surface layers 12 do not contain the cyclic olefin-based resin (do contain it in an amount of 0 parts by weight). When the surface layers 12 contain the cyclic olefin-based resin, the surface layers 12 contain the cyclic olefin-based in an amount of preferably 1 part by weight or more and less than 55 parts by weight, preferably 1 part by weight or more and 50 parts by weight or less, still more preferably 1 part by weight or more and 45 parts by weight or less, with respect to 100 parts by weight of the total of the thermoplastic resins contained in the surface layers 12.

### [Other Components]

In addition, additives such as an anti-blocking agent, an antioxidant, a heat stabilizer, an ultraviolet absorber, a light stabilizer, a lubricant, an antistatic agent, a flame retardant, an antibacterial agent, a fluorescent brightener, and a colorant may be added to the surface layers 12 as necessary.

### 3. Intermediate Layer

The intermediate layer 11 is a layer positioned on the inside of the film 10, and it is the layer with the highest ratio of thickness in the film 10. The intermediate layer contains one or a plurality of thermoplastic resins selected from a hydrocarbon resin, an ethylene-based resin, and a propylene-based copolymer resin. The hydrocarbon resin is one or a plurality of thermoplastic resins selected from a petroleum resin, a terpene resin, and a rosin resin. In addition, the intermediate layer 11 may contain or need not contain a cyclic olefin-based resin. Since the respective resins are as described in the description of the surface layers 12, description thereof is omitted. For these resins, resins having the same composition may be used for the surface layers 12 and the intermediate layer 11, or resins having different compositions may be used.

It is only necessary for the intermediate layer 11 to contain at least one of the hydrocarbon resin, the ethylene-based resin, and the propylene-based copolymer resin, and it is not necessary to contain all of them. However, the intermediate layer 11 preferably contains the hydrocarbon resin and the propylene-based resin. In this case, the intermediate layer 11 contains the petroleum resin in an amount of preferably 5 parts by weight or more and 40 parts by weight or less, more preferably 10 parts by weight or more and 35 parts by weight or less, still more preferably 15 parts by weight or more and 30 parts by weight or less, with respect to 100 parts by weight of the total of the thermoplastic resins contained in the intermediate layer 11. In addition, the intermediate layer 11 contains the propylene-based resin in an amount of preferably 50 parts by weight or more and 95 parts by weight or less, more preferably 60 parts by weight or more and 90 parts by weight or less, still more preferably 65 parts by weight or more and 85 parts by weight or less.

Similarly to the surface layers 12, it is particularly preferable that the intermediate layer 11 does not contain the cyclic olefin-based resin (does contain it in an amount of 0 parts by weight). On the other hand, the intermediate layer 11 can selectively contain raw materials regenerated from the film 10, intermediate products of the film 10, and the like as return raw materials, and in such cases, the cyclic olefin-based resin may be contained. When the intermediate layer 11 contains the cyclic olefin-based resin, the intermediate layer 11 contains the cyclic olefin-based resin such that the content ratio of the cyclic olefin-based resin with respect to 100 parts by weight of the total of the thermoplastic resins contained in the intermediate layer 11 is smaller than the content ratio of the cyclic olefin-based resin in the surface layers 12 with respect to 100 parts by weight of the total of the thermoplastic resins contained in the surface layers 12.

### [Other Components]

In addition, additives such as an antioxidant, a heat stabilizer, an ultraviolet absorber, a light stabilizer, a lubricant, an antistatic agent, a flame retardant, an antibacterial agent, a fluorescent brightener, and a colorant may be added to the surface layers 12 as necessary.

### 4. Thickness

The film 10 has a total thickness of preferably 20 μm or more and 70 μm or less, more preferably 30 μm or more and 60 μm or less, still more preferably 35 μm or more and 55 μm or less. When the thickness of the surface layers 12 is 1, the thickness of the intermediate layer 11 is preferably 3 or more and 8 or less, more preferably 4 or more and 7 or less.

### 5. Heat Shrinkage of Film

It is preferable that a heat shrinkage in a TD direction of film 10 is 50% or more when the film 10 is immersed in hot water at 90° C. for 10 seconds, then immediately taken out, immersed in water at 20° C., and taken out after 10 seconds.

### 6. Method for Producing Film

The method for producing the film 10 is not particularly limited, but a method of simultaneously molding each layer by a co-extrusion method is preferable. When the co-extrusion method is co-extrusion by a T-die, a lamination method may be any of a feed block method, a multi-manifold method, or a method using these methods in combination.

Specifically, for example, there is a method in which raw materials constituting the intermediate layer 11 and the surface layers 12 are each charged into an extruder, extruded into a sheet shape by a die, cooled and solidified by a take-off roll, and then stretched uniaxially or biaxially. As the above-described stretching method, for example, a roll stretching method, a tenter stretching method, or a combination thereof can be used. The stretching temperature is changed according to the softening temperatures of the resins constituting the film 10, shrinkage characteristics required for the film 10, and the like, but is preferably 65° C. or higher and 120° C. or lower, more preferably 70° C. or higher and 115° C. or lower.

The stretch ratio in the main shrinkage direction is changed according to the resins constituting the film 10, the stretching means, the stretching temperature, and the like, but is preferably 3 times or more and 7 times or less, more preferably 4 times or more and 6 times or less. Note that the MD (machine direction) direction of the film 10 corresponds to a longitudinal direction (second direction), and the TD (transverse direction) direction corresponds to a width direction (first direction). In the present embodiment, the TD direction is the main shrinkage direction.

### 7. Method for Producing Cylindrical Label

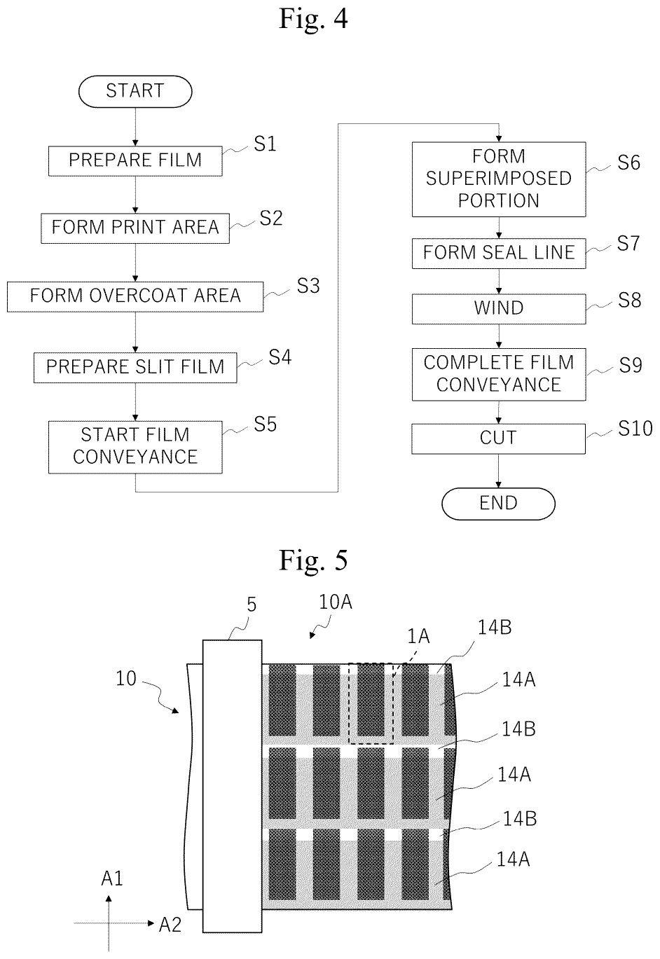

Hereinafter, the method for producing the cylindrical label 1 including the film 10 as a base material will be described. FIG. 4 is a flowchart showing a flow of the production method of the cylindrical label 1.

### [Preparation Step]

In the production method of the cylindrical label 1, first, the film 10 as described above is prepared (step S1). The film 10 is prepared in the form of a roll wound in the longitudinal direction in the present embodiment, and the roll is set in, for example, a conveying device (not illustrated). In such a conveying device, the planar-shaped film 10 is continuously ejected by rotating the roll in one direction.

### [Print Area Forming Step]

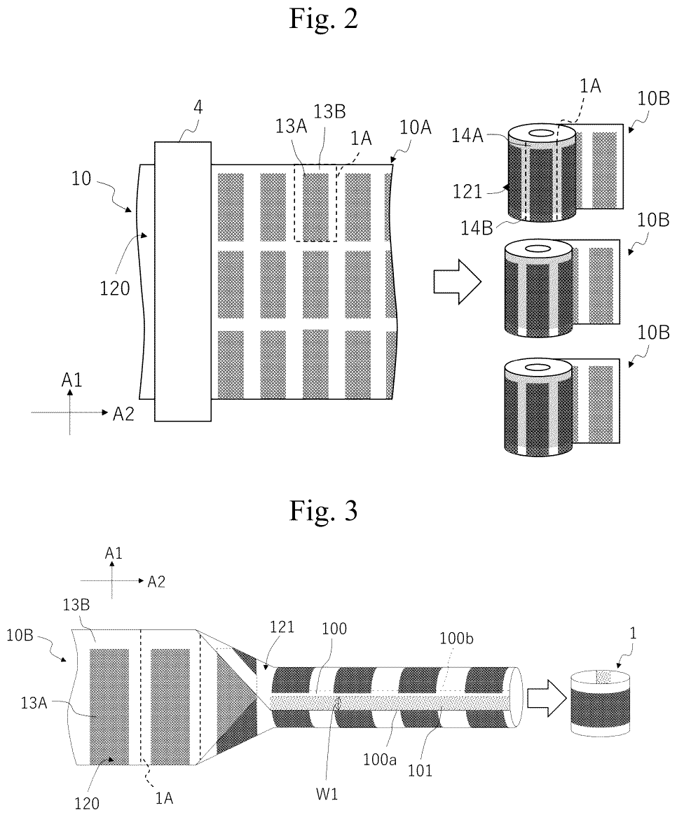

Subsequently, as illustrated in FIG. 2, while the film 10 is conveyed along the longitudinal direction (direction indicated by an arrow A2) at a constant conveying speed, a plurality of label designs are printed on the first surface 120 using a printing device 4 (step S2). The printing method includes, but is not specifically limited to, flexographic printing, planographic printing, gravure printing, screen printing, inkjet printing, and the like. The printing device 4 is configured to simultaneously print a plurality of designs of the cylindrical label 1 collocated in the width direction (direction indicated by an arrow A1) on the film 10 being conveyed. As a result, a printed film 10A is prepared from the film 10.

The printed film 10A is a film in which a plurality of label areas 1A are collocated regularly along the width direction and the longitudinal direction. The label area 1A displays the design of the cylindrical label 1 and later becomes the individual cylindrical label 1. In the drawing, only a representative label area 1A of the plurality of label areas 1A is provided with the reference numeral. The label area 1A of the present embodiment is collocated such that the axial direction and the circumferential direction of the cylindrical label 1 correspond to the longitudinal direction and the width direction, respectively.

The label area 1A on the first surface 120 is configured to have a print area 13A including one end in the width direction and a non-print area 13B including the other end in the width direction. In the drawing, only a representative print area 13A and a representative non-print area 13B of a plurality of print areas 13A and a plurality of non-print areas 13B are provided with the reference numerals. In the label area 1A of the present embodiment, the non-print area 13B extending in the longitudinal direction is on one end side in the width direction.

The print area 13A is an area formed with one or a plurality of ink layers laminated on the first surface 120. On the other hand, the non-print area 13B is an area that remains as a blank part without one or a plurality of ink layers being laminated (see FIG. 1B). As described above, in the individual label area 1A, the non-print area 13B is formed on one end side in the width direction so as to extend in the longitudinal direction. As a result, at least the non-print area 13B extending in the longitudinal direction is formed on the first surface 120 where the plurality of label areas 1A are collocated regularly.

### [Overcoat Area Forming Step]

Subsequently, for the printed film 10A, overcoat areas 14A are formed on the second surface 121 (step S3). The overcoat area 14A is an area where an overcoat agent is laminated to protect the second surface 121. The overcoat agent is constituted of a transparent colorless ink referred to as, for example, medium. Examples of the overcoat agent include, but are not specifically limited to, agents containing urethane resins and agents containing acrylic resins. On the other hand, a non-overcoat area 14B is an area that remains as a blank part without the overcoat agent being laminated (see FIG. 1B).

As illustrated in FIG. 2, the label area 1A has the overcoat area 14A including one end in the width direction and the non-overcoat area 14B including the other end in the width direction on the second surface 121. Preferably, the overcoat area 14A is disposed on the back side of the non-print area 13B, and the print area 13A is disposed on the back side of the non-overcoat area 14B. In FIG. 2, only a representative overcoat area 14A and a representative non-overcoat area 14B of a plurality of overcoat areas 14A and a plurality of non-overcoat areas 14B are provided with the reference numerals. In addition, these graphic indications are omitted for the convenience of explanation in FIG. 3.

The overcoat areas 14A can be formed, as illustrated in FIG. 5, for example, after the printed film 10A is flipped over, while the printed film 10A is conveyed in one direction, in a similar manner as is performed in step S2. The formation method of the overcoat area 14A is not specifically limited, and the overcoat areas 14A may be formed by applying the overcoat agent to the second surface 121, for example, using a known application device 5 used for medium printing. The application device 5 of the present embodiment is configured to apply the overcoat agent leaving a predetermined margin in the width direction. This results in forming, on the second surface 121, the overcoat areas 14A extending in the longitudinal direction and the non-overcoat areas 14B extending in the longitudinal direction, which are blank parts where the overcoat agent is not laminated.

### [Slit Film Preparation Step]

Subsequently, the printed film 10A where the print areas 13A and the overcoat areas 14A have been formed is slitted to prepare a plurality of slit films 10B (step S4). The slit method is not specifically limited as long as the method allows the label areas 1A to be cut and separated for each row in the longitudinal direction. Each of the slit films 10B may be wound in the longitudinal direction and put into the form of a roll.

The slit film 10B thus prepared includes the non-print area 13B that is continuous in the longitudinal direction on one end side in the width direction on the first surface 120 and the non-overcoat area 14B that is continuous in the longitudinal direction on the other end side in the width direction on the second surface 121.

### [Conveyance Start Step]

Subsequently, conveyance of the slit film 10B is started along the longitudinal direction at a constant conveyance speed (step S5). The conveyance can be performed by, for example, setting a roll of the slit film 10B in a conveying device (not illustrated), rotating the roll in one direction, and continuously ejecting the planar-shaped slit film 10B. As a result, a plurality of label areas 1A of the slit film 10B are ejected sequentially along the direction of the arrow A2 in FIG. 3.

The conveyance speed is preferably 100 m/min or more and less than 600 m/min, more preferably 100 m/min or more and 400 m/min or less, still more preferably 100 m/min or more and 200 m/min or less. By setting the conveyance speed within the above range, production efficiency can be maintained, while the sealing strength of the seal line 101, which is formed later, can be secured. In addition, appearance defects such as tearing, wrinkles, and waviness of the seal line 101 are suppressed. In the present embodiment, the conveyance speed of the slit film 10B corresponds to the formation speed of the seal line 101.

### [Superimposed Portion Forming Step]

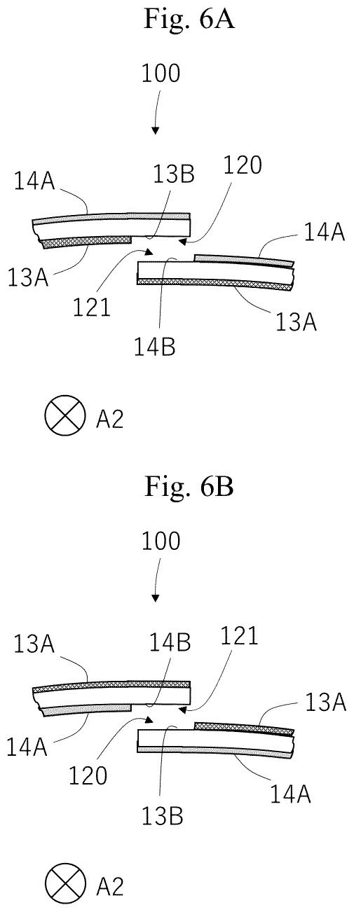

As the slit film 10B is conveyed as described above, one end portion and the other end portion in the width direction of the slit film 10B are stacked such that the first surface 120 and the second surface 121 face one another. As a result, a superimposed portion 100 extending along the longitudinal direction is formed (step S6). In the present embodiment, the end portions of the slit film 10B are stacked in an aspect in which the second surface 121 is an outer side surface of the superimposed portion 100 facing outward, and the first surface 120 is an inner side surface of the superimposed portion 100 facing inward. At this time, as illustrated in FIG. 6A, the non-print area 13B and the non-overcoat area 14B face one another at least partially in the superimposed portion 100.

Since the seal line 101 is formed in a range where the non-print area 13B and the non-overcoat area 14B face one another, it is preferable that a width by which these areas 13B and 14B face one another is sufficiently large with respect to a width W1 of the seal line 101. On the other hand, as long as the width by which these areas 13B and 14B face one another is secured sufficiently, the print area 13A and the overcoat area 14A may be included between the first surface 120 and the second surface 121 facing one another in the superimposed portion 100.

### [Seal Line Forming Step]

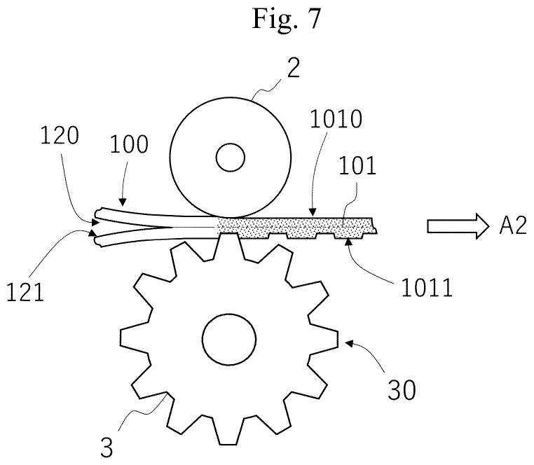

Subsequently, the slit film 10B in the superimposed portion 100 is continuously ultrasonically welded using an ultrasonic welding machine to form the seal line 101 that extends continuously along the longitudinal direction (step S7). The ultrasonic welding machine of the present embodiment includes an oscillator (not illustrated), an exciting device 2, and an anvil 3 (see FIG. 7). The exciting device 2 includes a vibrator, which vibrates when a predetermined voltage is applied from the oscillator, and a horn, which amplifies the amplitude of the vibrator and transmits the vibrations of the vibrator while applying pressure to an object to be welded. The exciting device 2 is disposed in a fixed position on an outer surface side of the superimposed portion 100 in advance. As a result, the slit film 10B including the superimposed portion 100 is conveyed at a constant speed with respect to the exciting device 2. The exciting device 2 of the present embodiment includes a rotary horn that rotates in conjunction with the convey ance of the slit film 10B.

The anvil 3 of the present embodiment is disposed in a position facing to the exciting device 2 on an inner surface side of the superimposed portion 100 in advance. The anvil 3 is a rigid member that is subjected to applied pressure from the exciting device 2 by sandwiching the object to be welded, and in the present embodiment, it is configured to be in the form of a roller that rotates in conjunction with the conveyance of the slit film 10B. As illustrated in FIG. 7, an unevenness is formed on an outer peripheral surface 30 of the anvil 3. The superimposed portion 100 is conveyed in a state where it is sandwiched between the exciting device 2 and the anvil 3 while being pressurized and is in contact with the outer peripheral surface 30. This results in forming the seal line 101 in which, in the superimposed portion 100, the thermoplastic resins in a part sandwiched between the exciting device 2 and the anvil 3 are welded one another. At the seal line 101, an anvil mark corresponding to the unevenness of the outer peripheral surface 30 of the anvil 3 is formed. This increases a contact area between the end portions of the slit film 10B melted by the frictional heat caused by mechanical vibration in the part sandwiched between the exciting device 2 and the anvil 3 and improves the sealing strength.

As described above, the seal line 101 is formed in the range where the non-print area 13B and the non-overcoat area 14B face one another in the superimposed portion 100. In other words, the seal line 101 is formed so as not to include the print area 13A and the overcoat area 14A between the first surface 120 and the second surface 121 facing one another. This promotes the thermoplastic resins constituting the first surface 120 and the second surface 121 directly melting and mixing together at the interface but suppresses the mixing of printing inks and overcoat agents that are foreign substances. Therefore, the sealing strength of the seal line 101 can be further improved.

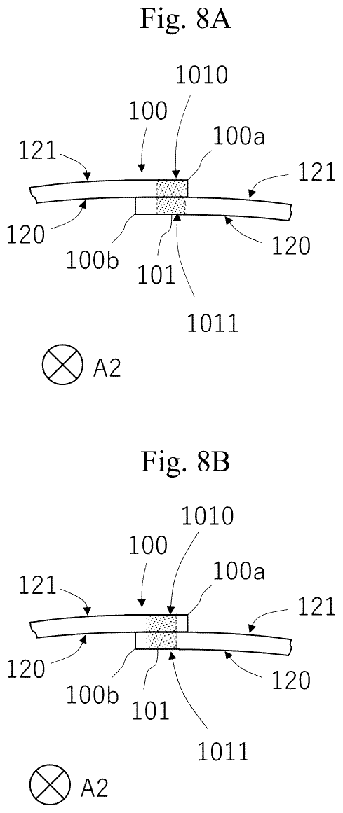

In addition, the seal line 101 need not be formed over the entire width direction of the superimposed portion 100, and it is only necessary for the seal line 101 to be formed over at least a part of the width direction of the superimposed portion 100. As illustrated in FIG. 8A, the seal line 101 is preferably formed to reach at least an outer end 100a of the slit film 10B. However, as illustrated in FIG. 8B for example, the seal line 101 may be formed between the outer end 100a and an inner end 100b without reaching the outer end 100a of the slit film 10B.

The exciting device 2 has a transmission vibration frequency of preferably 20 kHz or more and 40 kHz or less, more preferably 25 kHz or more and 35 kHz or less. By setting the transmission vibration frequency of the exciting device 2 within the above range, failures of the seal line 101 are less likely to occur after the cylindrical label 1 is attached to a container and thermally shrunk. Examples of failures after heat shrinkage include peeling of the seal line 101 itself and delamination between layers of the film 10 at the seal line 101, and these may be referred to as “displacement” of the seal line below (see FIG. 10).

The exciting device 2 has a transmission vibration frequency of preferably 20 kHz or more and 40 kHz or less, more preferably 25 kHz or more and 35 kHz or less. By setting the transmission vibration frequency of the exciting device 2 within the above range, failures of the seal line 101 are less likely to occur after the cylindrical label 1 is attached to a container and thermally shrunk. Examples of failures after heat shrinkage include peeling of the seal line 101 itself and delamination between layers of the film 10 at the seal line 101, and these may be referred to as “displacement” of the seal line below (see FIG. 10).

The width (seal width) W1 along the width direction of the seal line 101 is preferably 0.5 mm or more and 15 mm or less, preferably 1 mm or more and 10 mm or less, still more preferably 2 mm or more and 7 mm or less. By setting the seal width W1 to be equal to or more than the above lower limit, the sealing strength of the seal line 101 can be secured. On the other hand, by setting the seal width W1 to be equal to or less than the above upper limit, the cylindrical label 1 can be produced efficiently while maintaining good appearance of the cylindrical label 1.

As described above, when the anvil 3 with an unevenness formed on the outer peripheral surface 30 is used, the shape of the unevenness is not specifically limited. However, an arithmetic average roughness (surface roughness) Ra1 (μm) of an outer side surface 1010 at the seal line 101 and an arithmetic average roughness (surface roughness) Ra2 (μm) of an inner side surface 1011 at the seal line 101 preferably satisfy the relationship of Ra1<Ra2. The arithmetic average roughness Ra (μm) can be measured by a method in accordance with JIS B 0601:2013. The measuring range is a range including the section where the anvil mark has been formed on the seal line 101, and the reference length is 10 mm along the direction in which the seal line 101 extends.

From the viewpoint of suppressing damages to the seal line 101 by an impact such as falling, the arithmetic average roughness Ra1 (μm) and the arithmetic average roughness Ra2 (μm), a maximum height Rz1 (μm), and a maximum height Rz2 (μm) at the seal line 101 are preferably smaller.

The sealing strength (180° peel force) of the seal line 101 is preferably 1.5 N/10 mm or more. When the sealing strength is 1.5 N/10 mm or more, failures of the seal line 101 described above are less likely to occur even after the cylindrical label 1 is attached to a container and thermally shrunk.

### [Winding Step]

With reference to FIG. 4 again, in the present embodiment, the slit film 10B that has become a long cylindrical body with the seal line 101 formed is continuously wound from a leading end with the cylinder folded flat by a winding roll (not illustrated) (step S8). This results in forming, on the winding roll, a long cylindrical roll in which a plurality of cylindrical labels 1 are continuous in the longitudinal direction.

### [Conveyance Completion Step]

When the seal line 101 is formed until the end of the slit film 10B ejected from the roll and is wound by the winding roll as a long cylindrical body, the conveyance of one roll of the slit film 10B is completed (step S9).

### [Cutting Step]

After step S9, when each part between a cylindrical label 1 and a cylindrical label 1 adjacent to one another is cut in the resulting long cylindrical roll, a plurality of individualized cylindrical labels 1 having the seal line 101 extending in the axial direction are obtained (step S10).

### 8. Characteristics

With the film 10 according to the present embodiment, by not containing a cyclic olefin-based resin or setting the content ratio of the cyclic olefin-based resin, especially in the surface layers 12, to be less than 55 parts by weight, sebum whitening can be suppressed, and the manufacturing cost can be lowered. In addition, the surface layers 12 and the intermediate layer 11 contain one or a plurality of thermoplastic resins selected from a hydrocarbon resin, an ethylene-based resin, and a propylene-based copolymer resin, thereby making it possible to have a heat shrinkage in hot water at 90° C. of 50% or more. Further, since the film 10 has suitability for a sealing method by ultrasonic welding, it can be suitably used as a base material of the cylindrical label 1.

The sealing method by ultrasonic welding eliminates the use of a sealant such as tape and a solvent, allowing greenhouse gas emissions caused by the solvent to be reduced. In a sealing method using a solvent, the solvent may swell, and there is a problem that in the winding step, blocking is likely to occur between a seal line of a folded long cylindrical body and a part opposed to the seal line. The sealing method by ultrasonic welding can avoid blocking caused by such swelling of a solvent. In addition, since the seal line 101 of the cylindrical label 1 does not have a sealant layer between the first surface 120 and the second surface 121 facing one another, recycling efficiency and quality can be improved.

On the other hand, in a heat sealing method for applying heat to the slit film 10B, a lot of heat is required to weld the slit film 10B, and time for cooling after sealing is required. However, the above-described method does not require a lot of heat and cooling time. Therefore, from the viewpoint of energy saving and production efficiency, the above-described production method is superior.

### 9. Modifications

Although some embodiments of the present disclosure have been described above, the present disclosure is not limited to the above embodiments, and various modifications can be made without departing from the gist thereof. For example, the following modifications are possible. The gist of the following modifications can be appropriately combined.

### 9-1

The cross-sectional shape of the outer peripheral surface 30 of the anvil 3 is not specifically limited. From the viewpoint of setting the sealing strength of the seal line 101 within a preferable range, the anvil 3 preferably includes a plurality of projecting portions that project outward in a radial direction of the anvil 3.

### 9-2

The film 10 is not limited to having the three-layer structure as described above, and for example, it may have a five-layer structure or a structure including still more layers. In addition, the film 10 may be a biaxially stretched film or a uniaxially stretched film.

### 9-3

In the above-described embodiment, the slit film 10B that has become a long cylindrical body with the seal line 101 formed is wound by a winding roll. However, the winding step may be omitted, and the individualized cylindrical labels 1 may be obtained by sequentially cutting and separating the cylindrical labels 1 from the leading end of the slit film 10B that has become a long cylindrical body.

### 9-4

In the above-described embodiment, the superimposed portion 100 is formed such that the first surface 120 is the inner side surface and the second surface 121 is the outer side surface. However, the superimposed portion 100 may be formed such that the first surface 120 is the outer side surface and the second surface 121 is the inner side surface. In this case, as illustrated in FIG. 6B, the non-print area 13B and the non-overcoat area 14B may face one another at least partially in the superimposed portion 100, and it is only necessary to form the seal line 101 in the range where these areas face one another.

### 9-5

The conveyance speed of the film 10 means a speed relative to the exciting device 2. That is, in the above-described embodiment, the position of the exciting device 2 is fixed with respect to the conveyed film 10. However, the seal line 101 may be formed while the exciting device 2 moves along the longitudinal direction at a constant speed, and it is only necessary for the relative conveyance speed of the film 10 to the exciting device 2 to be 100 m/min or more and less than 600 m/min.

### 9-6

The label area 1A may be disposed such that the axial direction and the circumferential direction of the cylindrical label 1 correspond to the width direction and the longitudinal direction, respectively.

### 9-7

The formation of the overcoat area 14A and the non-overcoat area 14B may be performed simultaneously with the formation of the print area 13A and the non-print area 13B or may be performed before the formation of the print area 13A and the non-print area 13B. In addition, the formation of the overcoat area 14A and the non-overcoat area 14B itself can be omitted.

### 9-8

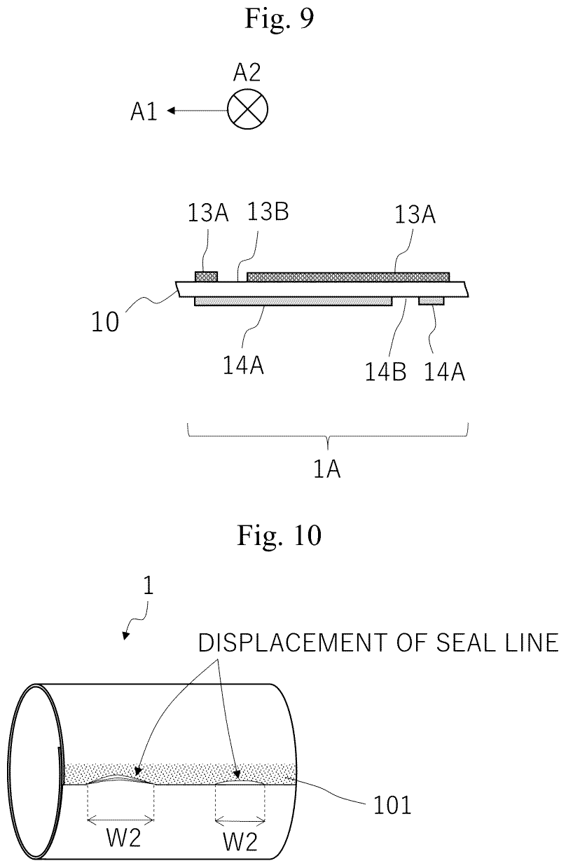

In the above-described embodiment, in the label area 1A, the print area 13A is formed to include one end in the width direction, and the non-print area 13B is formed to include the other end in the width direction. However, the arrangement of the print area 13A and the non-print area 13B is not limited to this. For example, as illustrated in FIG. 9, two print areas 13A having different sizes may be formed to include the respective ends in the width direction, and the non-print area 13B may be arranged in a position that is biased to one end side in the width direction. In addition, the overcoat area 14A and the non-overcoat area 14B may also be formed in a similar arrangement relationship on the second surface 121.

### EXAMPLES

Hereinafter, working examples of the present disclosure will be described in detail. However, the present disclosure is not limited to these working examples.

### 1. Preparation of Working Examples and Reference Example

As raw materials constituting an intermediate layer and surface layers laminated adjacent to both surfaces of the intermediate layer, the raw materials having physical properties shown in Table 1 were blended in the proportions shown in Table 2 to prepare respective resin compositions constituting the intermediate layer and the surface layers of heat shrinkable films according to Working Examples 1 to 11 and Comparative Example 1.

TABLE 1

| | | | | | | GLASS | VICAT | |
|---|---|---|---|---|---|---|---|---|
| | | | | MVR | MFR | TRANSITION | SOFTENING | SOFTENING |
| | | | DENSITY | (cm³/10 | (g/10 | TEMPERATURE | TEMPERATURE | POINT |
| | | COMPOSITION | (kg/m³) | min) | min) | (° C.) | (° C.) | (° C.) |
| CYCLIC | COC-1 | ETHYLENE-NORBORNENE | 1,010 | 27.0 | — | 65 | — | — |
| OLEFIN- | | COPOLYMER RESIN | | | | | | |
| BASED RESIN | COC-2 | ETHYLENE-NORBORNENE | 1,010 | 20.0 | — | 78 | — | — |
| | | COPOLYMER RESIN | | | | | | |
| ETHYLENE- | PE-1 | LINEAR LOW-DENSITY | 913 | — | 2.0 | — | 96 | — |
| BASED RESIN | | POLYETHYLENE | | | | | | |
| PROPYLENE- | PP-1 | PROPYLENE-ETHYLENE- | — | — | 5.5 | — | 115 | — |
| BASED RESIN | | BUTENE COPOLYMER | | | | | | |
| | PP-2 | PROPYLENE-ETHYLENE | — | — | 2.3 | — | 150 | — |
| | | COPOLYMER | | | | | | |
| | PP-3 | PROPYLENE-BUTENE | — | — | 7.0 | — | 67 | — |
| | | COPOLYMER | | | | | | |
| PETROLEUM | HC-1 | PETROLEUM RESIN | — | — | — | — | — | 125 |
| RESIN | | | | | | | | |

TABLE 2

| | | | | | | | | | | | | | | COMPARATIVE |
|---|---|---|---|---|---|---|---|---|---|---|---|---|---|---|
| | | | WORKING EXAMPLE | | | | | | | | | | | EXAMPLE |
| | | | 1 | 2 | 3 | 4 | 5 | 6 | 7 | 8 | 9 | 10 | 11 | 1 |
| SURFACE | CYCLIC OLEFIN- | COC-1 | — | 20 | 20 | — | — | — | — | — | — | — | — | 40 |
| LAYER | BASED RESIN | COC-2 | — | 20 | 20 | — | — | — | — | — | — | — | — | 45 |
| COMPOSITION | ETHYLENE- | PE-1 | 100 | 31 | 31 | — | — | — | — | — | — | — | — | 15 |
| (PARTS BY | BASED RESIN | | | | | | | | | | | | | |
| WEIGHT) | PROPYLENE- | PP-1 | — | 29 | 29 | 100 | — | — | — | — | — | — | — | — |
| | BASED RESIN | PP-2 | — | — | — | — | 30 | 50 | 70 | 70 | 70 | 70 | — | — |
| | | PP-3 | — | — | — | — | 70 | 50 | 30 | 30 | 30 | 30 | 100 | — |
| INTERMEDIATE | PROPYLENE- | PP-1 | 50 | 50 | 45 | 50 | 50 | 50 | 50 | 37 | 64.3 | 90 | 50 | 50 |
| LAYER | BASED RESIN | PP-2 | 25 | 25 | 22.5 | 25 | 25 | 25 | 25 | 40.6 | 5 | 0 | 25 | 25 |
| COMPOSITION | | PP-3 | 5 | 5 | 4.5 | 5 | 5 | 5 | 5 | 5 | 5 | 0 | 5 | 5 |
| (PARTS BY | PETROLEUM | HC-1 | 20 | 20 | 18 | 20 | 20 | 20 | 20 | 17.4 | 25.7 | 10 | 20 | 20 |
| WEIGHT) | RESIN | | | | | | | | | | | | | |
| | CYCLIC OLEFIN- | COC-1 | — | — | 5 | — | — | — | — | — | — | — | — | — |
| | BASED RESIN | COC-2 | — | — | 5 | — | — | — | — | — | — | — | — | — |

| | | | | | | | | | | | | |
|---|---|---|---|---|---|---|---|---|---|---|---|---|
| TOTAL THICKNESS (μm) | 50 | 50 | 50 | 50 | 50 | 50 | 50 | 50 | 50 | 50 | 50 | 50 |

For the above-described resin compositions, each of the resin compositions constituting the intermediate layer and the surface layers was melted, co-extruded from a T-die, and cooled and solidified with a roll cooled to 30° C. to prepare an unstretched resin film. This unstretched film was stretched 5 times in the TD direction with a tenter stretching machine at a temperature of 95° C. to prepare a heat shrinkable film having a three-layer structure in which the surface layers were laminated adjacent to both surfaces of the intermediate layer. The length, width, and thickness of the entire heat shrinkable film, the thickness of the intermediate layer, and the thickness of the surface layers were common in Working Examples 1 to 11 and Comparative Example 1, and the thickness ratio of surface layer/intermediate layer/surface layer was 1/6/1. The width direction of each heat shrinkable film was consistent with the TD direction.

By forming an ink layer on one surface of the heat shrinkable film, a printed film on which a plurality of label designs were printed was prepared. The plurality of label designs were collocated regularly in the longitudinal direction and the width direction. In any of the printed films, a label area to be one cylindrical label was configured such that a print area included one end in the width direction and a non-print area included the other end as illustrated in FIG. 2. These printed films were slitted in the longitudinal direction with a width of one row of the label area to prepare slit films on which the label areas were continuous in the longitudinal direction. The formation of an overcoat area was omitted.

The slit films according to Working Examples 1 to 11 and Comparative Example 1 were conveyed with respect to an ultrasonic welding machine (DUKANE ultrasonic sealing unit) at the conveyance speed (formation speed) shown in Table 3 to prepare long cylindrical bodies on which a seal line having a width of 3 mm was formed under the conditions (common) shown in Table 3. In each slit film, a superimposed portion was formed such that the surface (first surface) on which the print area was formed was facing inward, and the seal line was formed such that the print area was not included in the part where the first surface and a second surface faced one another.

TABLE 3

| | | | | | | | | | | | | COMPAR- |
|---|---|---|---|---|---|---|---|---|---|---|---|---|
| | | | | | | | | | | | | ATIVE |
| | WORKING EXAMPLE | | | | | | | | | | | EXAMPLE |
| | 1 | 2 | 3 | 4 | 5 | 6 | 7 | 8 | 9 | 10 | 11 | 1 |
| SEAL WIDTH | 3 | 3 | 3 | 3 | 3 | 3 | 3 | 3 | 3 | 3 | 3 | 3 |
| (mm) | | | | | | | | | | | | |
| FORMATION | 100 | 100 | 100 | 100 | 100 | 100 | 100 | 100 | 100 | 100 | 100 | 100 |
| SPEED (m/min) | | | | | | | | | | | | |
| FREQUENCY | 30 | 30 | 30 | 30 | 30 | 30 | 30 | 30 | 30 | 30 | 30 | 30 |
| [kHz] | | | | | | | | | | | | |
| KNURLING | YES | YES | YES | YES | YES | YES | YES | YES | YES | YES | YES | YES |

### 2. Evaluation

The heat shrinkable films, long cylindrical bodies, and cylindrical labels according to Working Examples 1 to 11 and Comparative Example 1 were evaluated as follows.

### 2-1. Heat Shrinkage

Five samples each having a size of 100 mm in the TD direction and 100 mm in the MD direction were cut out from arbitrary portions of the heat shrinkable films according to Working Examples 1 to 11 and Comparative Example 1. Each sample was immersed in hot water at 90° C. for 10 seconds, then immediately taken out, immersed in water at 20° C., and taken out after 10 seconds. Thereafter, a length L (mm) in the TD direction of each sample was measured, and the shrinkage (%) in the TD direction was each calculated according to the following formula. For the heat shrinkable films according to Working Examples 1 to 11 and Comparative Example 1, the average value of the shrinkage of each sample was taken as the heat shrinkage.

$$Shrinkage ( \% ) = \{ ( 100 - L ) / 100 \} \times 100$$

The evaluation of the heat shrinkage was as follows.
Evaluation A: Heat shrinkage of 50% or more (heat shrinkage is adequate)
Evaluation B: Heat shrinkage of less than 50% (heat shrinkage is inadequate)

### 2-2. Sealing Strength

Five cylindrical samples each having a length in the longitudinal direction of 10 mm were cut out from the long cylindrical bodies according to Working Examples 1 to 11 and Comparative Example 1. For each sample, the opposite side of the seal line was cut open to prepare a strip-shaped sample of about 20 cm with the seal line disposed in the center. Using the samples, the peel force in the 180° direction was measured by an adhesion and peeling resistance tester (HEIDON TYPE 17, manufactured by Shinto Scientific Co., Ltd.), and the average value of the five samples was taken as the sealing strength for Working Examples 1 to 11 and Comparative

### Example 1. The preferred sealing strength was 1.5 N/10 mm or more.

### 2-3. Surface Roughness of Seal Line

Five planar-shaped samples each including a portion of the seal line were cut out from the long cylindrical bodies according to Working Examples 1 to 11 and Comparative Example 1. For these samples, the surface roughness on the outer side surface and the surface roughness on the inner side surface of the seal line were each measured in accordance with JIS B 0601:2013 (reference length 10 mm). From these measurement values, the average values of the five samples were calculated and taken as the surface roughness Ra1 (μm) on the outer side surface and the surface roughness Ra2 (μm) on the inner side surface for each.

### 2-4. Maximum Height of Seal Line

For these samples from the long cylindrical bodies according to Working Examples 1 to 11 and Comparative Example 1, the maximum height of the outer side surface and the maximum height of the inner side surface of the seal line were each measured (reference length 10 mm). From these measurement values, the average values of the five samples were calculated and taken as the maximum height Rz1 (μm) of the outer side surface and the maximum height Rz2 (μm) of the inner side surface for each.

### 2-5. Appearance Inspection of Seal Line

Five cylindrical samples each were cut out from the long cylindrical bodies according to Working Examples 1 to 11 and Comparative Example 1 to confirm whether or not tearing, wrinkles, and waviness occurred on the seal line. The evaluation of the appearance was as follows.
Evaluation A: No tearing, wrinkles, or waviness were observed in all five samples.
Evaluation B: There was a sample with at least one of the observed tearing, wrinkles, and waviness.

### 2-6. Post-Heat Shrinkage Displacement Inspection

Five cylindrical samples each having a folded diameter of 108.5 mm and a length in the longitudinal direction of 100 mm were cut out from the long cylindrical bodies according to Working Examples 1 to 11 and Comparative Example 1 to prepare cylindrical labels. A general beverage bottle can (with a lid closed) was covered with the cylindrical label, the lower end of the cylindrical label was first immersed in boiling water at 100° C. for one second to secure the cylindrical label to the bottle can, and then, the entire label was immersed in boiling water for 30 seconds so as not to displace the cylindrical label from the bottle can. Thereafter, the cylindrical label was cut open with a cutter and removed from the bottle can, and the moisture was wiped off. Portions bent due to the shape of the bottle can were removed from the cylindrical label that was cut open, and a sample containing the seal line was cut out and affixed to a mount with double-sided tape to confirm with a microscope whether or not there was displacement on the seal line. The evaluation of the displacement was as follows.
Evaluation A: No displacement was observed in all the samples.
Evaluation B: There was a sample with displacement observed.

### 2-7. Cold-Resistant Bending Displacement Inspection

Four cylindrical samples each having a folded diameter of 108.5 mm and a length in the longitudinal direction of 100 mm were cut out from the long cylindrical bodies according to Working Examples 1 to 11 and Comparative Example 1 to prepare cylindrical labels. These cylindrical labels were allowed to stand in a constant temperature and humidity chamber set at 5° C. for one hour. Subsequently, under the same environment, each cylindrical label was held so as to sandwich the seal line of each cylindrical label, folded in a range of −90° to 90° with respect to the longitudinal direction, and bent 20 times. After this bending motion was performed evenly at four portions in the longitudinal direction of the seal line, the constant temperature and humidity chamber was set to an environment of 23° C. and 50% RH, and each cylindrical label was allowed to stand in the chamber for one hour. Then, each cylindrical label was covered on a general beverage bottle can (with a lid closed), the lower end of the cylindrical label was first immersed in boiling water at 100° C. for one second to secure the cylindrical label to the bottle can, and then, the entire label was immersed in boiling water for 10 seconds so as not to displace the cylindrical label from the bottle can. Thereafter, the seal line was observed with a microscope, similarly to the post-heat shrinkage displacement inspection, to confirm whether or not there was displacement. The evaluation of the displacement was the same as the post-heat shrinkage displacement inspection.

### 2-8. Bending Heat-Resistant Displacement Inspection

Similarly to the post-heat shrinkage displacement inspection and the cold-resistant bending displacement inspection, cylindrical labels according to Working Examples 1 to 11 and Comparative Example 1 were prepared. Under an environment of 23° C., five portions in the longitudinal direction of the seal line of each cylindrical label were bent 20 times each in a similar manner to the cold-resistant bending displacement inspection. Then, a glass bottle was covered with each cylindrical label, and a hot-air type shrink machine (TORNADO 2001, manufactured by Nippon Technology Solution Co., Ltd.) was used to shrink and attach the cylindrical label to the glass bottle under the conditions of a preheating part temperature of 140° C. with an air volume of 30 Hz, a heating part at 250° C. with an air volume of 40 Hz, and a tunnel passing time of 33 s. The direction of the glass bottle in the hot-air type shrink machine was adjusted such that the hot air directly hit the seal line of the cylindrical label.

Thereafter, the cylindrical label was cut open with a cutter and removed from the glass bottle, and a length W2 along the longitudinal direction of displacement of the seal line that occurred was measured (see FIG. 10). However, if displacement occurred intermittently in the longitudinal direction, the sum of the lengths W2 of the respective displacements was taken as the length of displacement. The same test was performed 20 times, and the average value of the length of displacement (the sum of the lengths W2) was calculated. The evaluation of the displacement length was as follows.
Evaluation A: The length of displacement was less than 10 mm (displacement was suppressed).
Evaluation B: The length of displacement was 10 mm or more (displacement easily occurred).

### 2-9. Sebum Whitening Resistance

The evaluation of sebum whitening resistance was as follows. Samples having a size of 150 mm in length × 250 mm in width were cut out from the heat shrinkable films according to Working Examples 1 to 11 and Comparative Example 1, and two marked lines in a lengthwise direction were drawn such that the distance between the marked lines was 150 mm. The above samples touched a plurality of times with a finger to which sebum around the nose was attached were immersed in hot water at 80° C. for seven seconds to be shrunk such that the distance between the marked lines became 135 mm, and then evaluated as evaluations A and B in the order of good (low) degree of sebum whitening. That is, evaluation A indicates having relatively high grease resistance, and evaluation B indicates having grease resistance that falls below the standard.

### 3. Evaluation Results

The evaluation results were as shown in Table 4 below.

TABLE 4

| | | | | | | | | | | | | | COMPAR- |
|---|---|---|---|---|---|---|---|---|---|---|---|---|---|
| | | | | | | | | | | | | | ATIVE |
| | | WORKING EXAMPLE | | | | | | | | | | | EXAMPLE |
| | | 1 | 2 | 3 | 4 | 5 | 6 | 7 | 8 | 9 | 10 | 11 | 1 |
| HEAT SHRINKAGE | | A | A | A | A | A | A | A | A | A | A | A | A |
| PEEL FORCE (N/10 mm) | | 3.0 | 2.2 | 2.0 | 1.6 | 2.8 | 2.4 | 2.1 | 2.2 | 1.9 | 2.0 | 4.0 | 3.8 |
| OUTER SIDE | SURFACE | 2.0 | 0.6 | 0.7 | 0.6 | 1.6 | 1.1 | 0.7 | 0.7 | 0.6 | 0.7 | 2.5 | 2.5 |
| SURFACE | ROUGHNESS Ra1 | | | | | | | | | | | | |
| | MAXIMUM | 4.9 | 2.5 | 2.4 | 2.1 | 3.8 | 2.7 | 2.4 | 2.6 | 2.2 | 2.4 | 5.8 | 5.5 |
| | HEIGHT Rz1 | | | | | | | | | | | | |
| INNER SIDE | SURFACE | 3.5 | 1.8 | 1.8 | 1.6 | 3.1 | 2.4 | 1.7 | 1.8 | 1.8 | 1.8 | 4.2 | 4.0 |
| SURFACE | ROUGHNESS Ra2 | | | | | | | | | | | | |
| | MAXIMUM | 9.8 | 4.3 | 4.1 | 4.1 | 7.5 | 5.1 | 4.0 | 4.5 | 4.1 | 4.5 | 10.9 | 11.0 |
| | HEIGHT Rz2 | | | | | | | | | | | | |
| SEBUM WHITENING | | A | A | A | A | A | A | A | A | A | A | A | B |
| APPEARANCE INSPECTION | | A | A | A | A | A | A | A | A | A | A | A | A |
| EVALUA- | DISPLACEMENT | A | A | A | A | A | A | A | A | A | A | B | A |
| TION | (100° C., 30 seconds) | | | | | | | | | | | | |
| AFTER | COLD-RESISTANT | A | A | A | A | A | A | A | A | A | A | A | A |
| ATTACH- | BENDING | | | | | | | | | | | | |
| MENT | (5° C. × 20 times) | | | | | | | | | | | | |
| | BENDING | A | A | A | A | A | A | A | A | A | A | B | A |
| | HEAT-RESISTANT | | | | | | | | | | | | |
| | DISPLACEMENT | | | | | | | | | | | | |
| | LENGTH | | | | | | | | | | | | |

In Working Examples 1 to 11, good results were obtained, in which the heat shrinkage of 50% or more was obtained, there were no problems with the peel force and appearance of the seal portion, and further, the sebum whitening was well suppressed. As a result, it was confirmed that a heat shrinkable multilayer film having a sufficiently high heat shrinkage and suitability for ultrasonic welding and hardly causing sebum whitening after heat shrinkage can be obtained without containing a large amount of expensive cyclic olefin-based resin. However, in the heat shrinkable film according to Working Example 11, displacement of the seal line occurred in the evaluation after the cylindrical label was prepared and attached to the bottle. On the other hand, in Comparative Example 1, sebum whitening was observed, although there were no problems with the heat shrinkage, the peel force of the seal portion, the appearance, or the displacement after the attachment to the bottle.

### REFERENCE SIGNS LIST

1 Cylindrical label
2 Exciting device
3 Anvil
10 Heat shrinkable film
10A Printed film
10B Slit film
11 Intermediate layer
12 Surface layer
13A Print area
13B Non-print area
30 Outer peripheral surface
100 Superimposed portion
101 Seal line
120 First surface
121 Second surface
1010 Outer side surface
1011 Inner side surface

1. A heat shrinkable multilayer film comprising:
a pair of surface layers; and
an intermediate layer disposed between the pair of surface layers,
wherein each of the surface layers contains one or a plurality of thermoplastic resins selected from one or a plurality of hydrocarbon resins, an ethylene-based resin, and a propylene-based copolymer resin in a combined amount of 45 parts by weight or more with respect to 100 parts by weight of a total of thermoplastic resins contained in the surface layers and does not contain a cyclic olefin-based resin or contains a cyclic olefin-based resin in an amount of more than 0 parts by weight and less than 55 parts by weight, the one or the plurality of hydrocarbon resins being selected from a petroleum resin, a terpene resin, and a rosin resin, and
the intermediate layer contains one or a plurality of thermoplastic resins selected from one or a plurality of hydrocarbon resins, an ethylene-based resin, and a propylene-based copolymer resin and does not contain a cyclic olefin-based resin or contains a cyclic olefin-based resin such that a content ratio of a cyclic olefin-based resin with respect to 100 parts by weight of a total of thermoplastic resins contained in the intermediate layer is lower than a content ratio of a cyclic olefin-based resin in the surface layers, the one or the plurality of hydrocarbon resins being selected from a petroleum resin, a terpene resin, and a rosin resin.

2. The heat shrinkable multilayer film according to claim 1,
wherein the surface layers contain the cyclic olefin-based resin.

3. The heat shrinkable multilayer film according to claim 2,
wherein the surface layers contain the cyclic olefin-based resin in an amount of 1 part by weight or more with respect to 100 parts by weight of a total of thermoplastic resins contained in the surface layers.

4. The heat shrinkable multilayer film according to claim 3,
wherein the intermediate layer contains the cyclic olefin-based resin.
